(19) United States
(12) Patent Application Publication
(10) Pub. No.: US 2020/0285791 A1
(43) Pub. Date: Sep. 10, 2020

(54) CIRCUIT DESIGN METHOD AND ASSOCIATED COMPUTER PROGRAM PRODUCT

(71) Applicant: Realtek Semiconductor Corp., Hsinchu (TW)

(72) Inventors: I-Hsiu Lo, Hsinchu County (TW); Wan-Ju Wu, Taoyuan City (TW); Yung-Jen Chen, Hsinchu County (TW); Yu-Lan Lo, Hsinchu County (TW); Shu-Yi Kao, Hsinchu County (TW)

(21) Appl. No.: 16/802,573

(22) Filed: Feb. 27, 2020

(30) Foreign Application Priority Data
Mar. 6, 2019 (TW) 108107337

(51) Int. Cl. G06F 30/327; G06F 30/3308

(52) U.S. Cl. CPC G06F 30/327; G06F 2119/16; G06F 30/3308

(57) ABSTRACT

The present invention provides a circuit design method, wherein the circuit design method includes the steps of: generating a gate-level netlist; determining at least one specific cell within a circuit according to the gate-level netlist, wherein an output signal of the at least one specific cell is always a fixed value; and replacing at least one specific cell by a tie cell to generate an updated gate-level netlist.

### BACKGROUND OF THE INVENTION

### 1. Field of the Invention

The present invention relates to a circuit design method.

### 2. Description of the Prior Art

In a conventional design flow of an integrated circuit (IC), the designer first uses the hardware description language to design the circuit function for the register transfer level (RTL), and then a logic synthesis tool is used to convert the design into a gate-level netlist of the actual semiconductor technologies, taking into account various conditions. In this conversion process, the logic synthesis tool tries to optimize the logic. However, due to the increasing complexity of the design, the algorithms in synthesis tools are usually very complicated, and the designer need to set various settings and iteratively adjust the setting for better circuit performance. Unfortunately, there is no guarantee that the internal circuit will be globally optimized.

### SUMMARY OF THE INVENTION

It is therefore an objective of the present invention to provide a circuit design method, which can re-optimize the gate-level netlist generated by the logic synthesis operations, to solve the above-mentioned problems.

In one embodiment of the present invention, a circuit design method is disclosed, wherein the circuit design method comprises the steps of: generating a gate-level netlist; determining at least one specific cell within a circuit according to the gate-level netlist, wherein an output signal of the at least one specific cell is always a fixed value; and replacing at least one specific cell by a tie cell to generate an updated gate-level netlist.

In another embodiment of the present invention, a computer program product used for a circuit design is disclosed, wherein the computer program product is executed by a computer to perform the steps of: determining at least one specific cell within a circuit according to a gate-level netlist, wherein an output signal of the at least one specific cell is always a fixed value; and replacing at least one specific cell by a tie cell to generate an updated gate-level netlist.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a circuit design method according to one embodiment of the present invention.

FIG. 2 is a diagram of using a tie cell to replace the specific cell whose output signal is always a fixed value.

FIG. 3A-FIG. 3C are diagrams of determining and removing the redundant cell(s).

### DETAILED DESCRIPTION

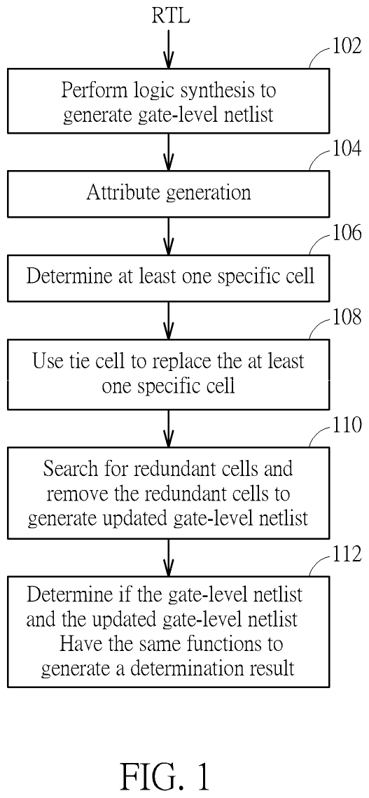

FIG. 1 is a flowchart of a circuit design method according to one embodiment of the present invention. In this embodiment, the circuit design method is executed by using a plurality of program instructions after a computer program product is loaded and executed by a computer/processor. Refer to FIG. 1, the flow of the circuit design method is described below.

In Step 102, the processor performs a logic synthesis operation according to an RTL design and specific constraints to generate a gate-level netlist, wherein the constraints may be clock frequency, pin function and/or other parameters that are entered by the engineer, and the gate-level netlist is a file format describing the circuit, which is logically identical to the RTL design.

In Step 104, the processor performs an attribute generation setting on the gate-level netlist. Specifically, in the present embodiment, the attribute describes a cell whether it always outputs a fixed value (that is, a cell whose output signal is always “1” or always “0”). The processor can put an attribute to detect signal variation at the output terminals of a cell in the gate-level netlist. The attributes can be expressed by SystemVerilog assertions, but it is not limited thereto.

In Step 106, the processor uses a formal method to determine if the attribute generated in Step 104 is met in the circuit of the gate-level netlist generated in Step 102, that is, the processor performs the attribute verification to determine at least one specific cell. Specifically, the processor uses the formal method to determine whether the output signal of each cell in the circuit will change. If the output signal of the cell changes, the verification attribute is met; and if the output signal of the cell does not change, the verification attribute is not met. Therefore, the processor can collect the cells whose attribute verification is not met as the specific cells whose output signals are always fixed values.

It is noted that the formal method is a computer science term, whose core is model-checking or property-checking. Because the formal method is based on rigorous mathematical proof, the formal method has higher reliability and it is possible to accurately find all the specific cells, whose output signals are always fixed values, in the circuit described in the gate-level netlist. In addition, because the present invention does not focus on the details of the formal method, the detailed descriptions of the formal method are therefore omitted here.

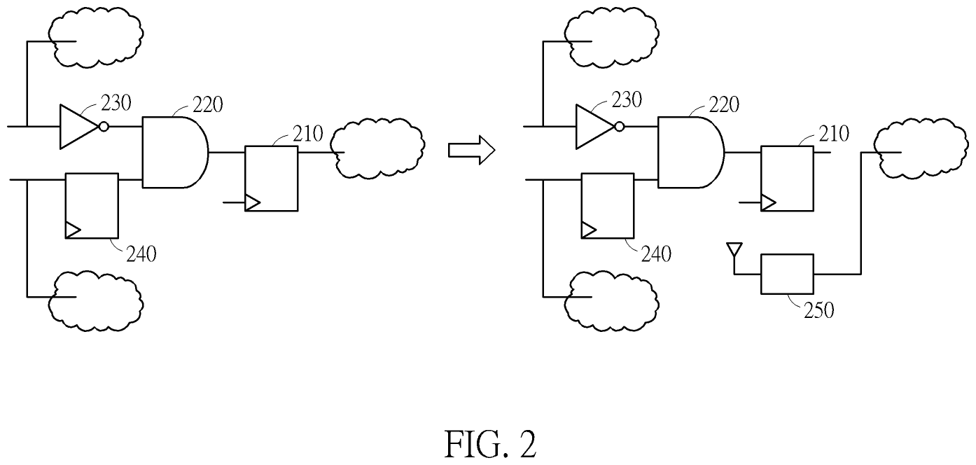

In Step 108, after determining all the specific cells that always output fixed values in the circuit, the processor adds a tie cell to the gate-level netlist to replace the function of the specific cell. That is, the output signal of the tie cell is used to replace the output signal of the specific cell, where the tie cell can be the simplest cell outputting the fixed value. For example, Referring to FIG. 2A, it is assumed that the circuit includes a flip-flop 210, an AND gate 220, an inverter 230 and a flip-flop 240, and the processor determines that the output signal of the flip-flop 210 is always the logic value “1” in Step 106, the processor can modify the description in the gate-level netlist to add a tie cell 250 whose output signal is always the logic value “1” to replace the flip-flop 210. That is, the output terminal of the tie cell 250 is connected to the cells which previously connected from the output of the flip-flop 210, and the output terminal of the flip-flop 210 is cut to a floating state. After the output signals of all the specific cells in the gate-level netlist are replaced by the tie cells, the processor generates a temporary gate-level netlist.

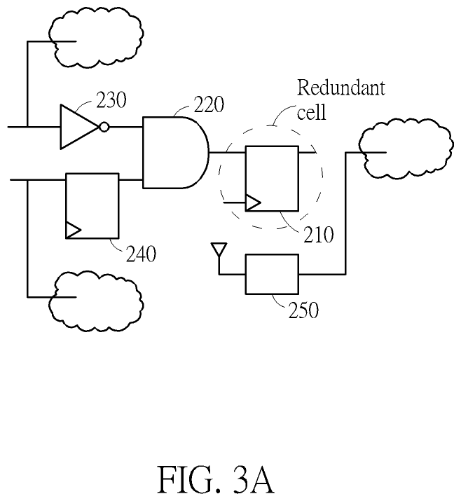

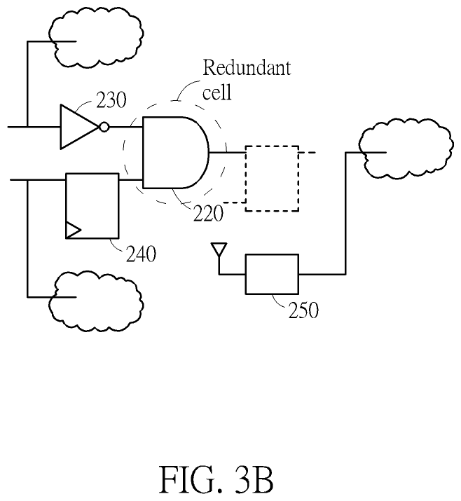

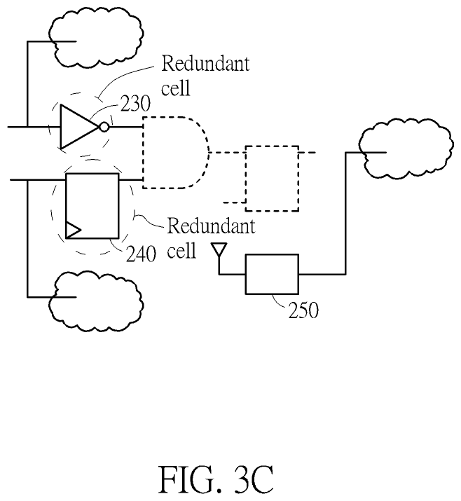

In Step 110, the processor repeatedly searches for redundant cells in the temporary gate-level netlist that do not have any function, and removes these redundant cells from the circuit to generate an updated gate-level netlist. Specifically, referring to FIG. 3A to FIG. 3C, the processor first detects that the output terminal of the flip-flop 210 is floating (i.e. the output signal of the flip-flop 210 is not forwarded to any other cell), that is, the flip-flop 210 is redundant cell, so the processor can remove the flip-flop 210 from the temporary gate-level netlist. Then, after the flip-flop 210 has been removed (FIG. 3B), the processor will detect that the output terminal of the AND gate 220 is floating (i.e. the output signal of the AND gate 220 is not forwarded to any other cell), that is, the AND gate 220 is redundant cell, so the processor can remove the AND gate 220 from the temporary gate-level netlist. Then, after the AND gate 220 has been removed (FIG. 3C), the processor will detect that the output terminals of the inverter 230 and the flip-flop 240 are floating, that is, the inverter 230 and the flip-flop 240 are redundant cells, so the processor can remove the inverter 230 and the flip-flop 240 from the temporary gate-level netlist. After all the redundant cells in the temporary gate-level netlist are removed, the processor generates the updated post-level netlist.

In Step 112, the processor may determine whether the functions of the gate-level netlist and the updated gate-level netlist are the same by using the normal method to generate a determination result. Specifically, the processor may use a logic equivalence check (LEC) or a sequential equivalence check (SEC), and test the gate-level netlist and the updated gate-level netlist to determine if the gate-level netlist and the updated gate-level netlist have the same output results while receiving the same input signals, to determine if the functions of the gate-level netlist and the updated gate-level netlist are the same. If the determination result indicates that the gate-level netlist and the updated gate-level netlist have the same functions, it means that the updated gate-level netlist has a simpler architecture than the gate-level netlist generated in Step 102, and the updated gate-level netlist can be used for the subsequent physical circuit layout.

Briefly summarized, in the circuit design method of the present invention, by replacing the specific cell whose output signal is always a fixed value by a tie cell with less chip area, and removing the redundant cells repeatedly after completing the tie cell replacement, the circuit architecture can become simpler while maintaining the same functions to generated the optimized gate-level netlist. By using the circuit design method of the present invention, the problems that the optimization ability of the conventional logic synthesis tool is insufficient or the RTL design cannot be well matched can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit design method, comprising:
generating a gate-level netlist;
determining at least one specific cell of a circuit according to the gate-level netlist, wherein an output signal the at least one specific cell is always a fixed value; and
using a tie cell to replace the at least one specific cell of the circuit to generate an updated gate-level netlist.

2. The circuit design method of claim 1, wherein the step of using the tie cell to replace the at least one specific cell of the circuit to generate the updated gate-level netlist comprises:
replacing the at least one specific cell by the tie cell, and searching for at least one redundant cell after the at least one specific cell is replaced by the tie cell, and removing the at least one redundant cell from the circuit to generate the updated gate-level netlist.

3. The circuit design method of claim 2, wherein the step of searching for the at least one redundant cell after the at least one specific cell is replaced by the tie cell comprises:
searching for a cell whose output terminal is floating to serve as the at least one redundant cell.

4. The circuit design method of claim 1, further comprising:
determining if the gate-level netlist and the updated gate-level netlist have the same functions or not to generate a determination result.

5. The circuit design method of claim 4, wherein the step of determining if the gate-level netlist and the updated gate-level netlist have the same functions or not to generate the determination result comprises:
using a sequential equivalent check (SEC) to determining if the gate-level netlist and the updated gate-level netlist have the same functions or not to generate the determination result.

6. A computer program product for a circuit design, wherein when the computer program product is executed by a computer, the computer program product executes the steps of:
determining at least one specific cell of a circuit according to a gate-level netlist, wherein an output signal the at least one specific cell is always a fixed value; and
using a tie cell to replace the at least one specific cell of the circuit to generate an updated gate-level netlist.

7. The computer program product of claim 6, wherein the step of using the tie cell to replace the at least one specific cell of the circuit to generate the updated gate-level netlist comprises:
replacing the at least one specific cell by the tie cell, and searching for at least one redundant cell after the at least one specific cell is replaced by the tie cell, and removing the at least one redundant cell from the circuit to generate the updated gate-level netlist.

8. The computer program product of claim 7, wherein the step of searching for the at least one redundant cell after the at least one specific cell is replaced by the tie cell comprises:
searching for a cell whose output terminal is floating to serve as the at least one redundant cell.

9. The computer program product of claim 6, further comprising:
determining if the gate-level netlist and the updated gate-level netlist have the same functions or not to generate a determination result.

10. The computer program product of claim 9, wherein the step of determining if the gate-level netlist and the updated gate-level netlist have the same functions or not to generate the determination result comprises:
using a sequential equivalent check (SEC) to determining if the gate-level netlist and the updated gate-level netlist have the same functions or not to generate the determination result.
